(19) United States
(12) Patent Application Publication
(10) Pub. No.: US 2002/0040273 A1
(43) Pub. Date: Apr. 4, 2002

(54) System and method for analyzing data contained in a computerized database

(76) Inventors: Michael J. John, Champlin, MN (US); Don P. Kackman, Minneapolis, MN (US); Todd Ell, Savage, MN (US)

Correspondence Address: David R. Fairbairn, THE KINNEY & LANGE BUILDING, 312 South Third Street, Minneapolis, MN, 55415-1002, US

(21) Appl. No.: 09/874,928

(22) Filed: Jun. 5, 2001

Related U.S. Application Data
(60) Provisional application No. 60/209,254, filed on Jun. 5, 2000.

(51) Int. Cl. G06F 19/00

(52) U.S. Cl. 702/5

(57) ABSTRACT

A software-based system and method for analyzing data contained in a computerized database. A plan document specifies data to be used by each of a plurality of software modules. A decision tree document identifies a set of the software modules to be invoked and specifies an order in which the identified set of software modules are to be invoked. Each of the identified set of software modules are provided a version of the plan document. Each version of the plan document provided to each of the identified set of software modules is transformed into a transformed plan document such that each one of the identified set of software modules has an associated transformed plan document. The identified set of software modules are invoked in the order specified in the decision tree. Each of the identified set of software modules performs operations using data from the transformed plan document associated with the software module. The identified set of software modules retrieves data from the computerized database and processes the retrieved data.

### CROSS-REFERENCE TO RELATED APPLICATION(S)

Cross-reference to the following applications: System and Method for Creating Field Attribute Maps for Site-Specific Farming, Ser. No. ______; System and Method for Creating Crop Input Requirement Maps for Site-Specific Farming, Ser. No. ______; System and Method for Creating Demo Application Maps for Site-Specific Farming, Ser. No. ______; System and Method for Creating Controller Application Maps for Site-Specific Farming, Ser. No. ______; and System and Method for Providing Site-Specific Farming Profit Analysis, Ser. No. ______. The above applications are filed on even date with this application and are assigned to AGCO Corporation, the same assignee as the present invention.

### BACKGROUND OF THE INVENTION

The present invention is a software-based system and method for accessing information from a database and processing that information, and more specifically a software-based process for accessing agronomic data from a database and generating application maps to be used in site-specific farming.

The management of crop production can be enhanced by taking into account spatial variations that exist within a given agricultural field. By varying the crop inputs across a field, crop yields can be improved and the environmental impact more closely controlled. The variation of crop inputs is commonly referred to as site-specific farming.

Site-specific farming involves the collection and processing of data relating to the agronomic characteristics of a field. Agronomic data is collected for specific field locations that may vary in size. The agronomic data is stored in various databases. The information collected for each field location is used to determine the crop inputs for each location. The information is combined with pre-defined and user-defined recommendation equations to determine the prescription of crop inputs required for a specific location. Once the prescription is determined for each location in a field, an agronomic prescription map is created for the entire field. The agronomic prescription map is then used to produce an application map, which identifies actual products to be added to a field on a site specific basis.

A control system reads the information from the application map and generates control signals for various applicators on an agricultural vehicle. The agricultural vehicle is designed to vary the application of products based on the application map as the vehicle traverses a field.

Ag-Chem Equipment Co., Inc., the assignee of the present invention, has developed numerous site specific farming methods and products, which are described in the following U.S. Patents: U.S. Pat. No. Re. 35,100, entitled “VARIABLE RATE APPLICATION SYSTEM”, U.S. Pat. No. 4,717,077, entitled “SELF-ALIGNING COUPLER FOR FLUID TRANSMITTING CONDUITS”, U.S. Pat. No. 5,220,876, entitled “VARIABLE RATE APPLICATION”, U.S. Pat. No. 5,114,078, entitled “BAFFLE SYSTEM FOR PNEUMATIC APPLICATORS OF SOLID PARTICLES”, U.S. Pat. No. Des. 351,843, entitled “AGRICULTURAL IMPLEMENT”, U.S. Pat. No. 5,271,567 entitled “FERTILIZER DISTRIBUTION HEAD AND DISPENSING CHUTE”, U.S. Pat. No. 5,282,644, entitled “HYDRAULICALLY ADJUSTABLE TIE-ROD FOR AN AGRICULTURAL VEHICLE WITH AN ADJUSTABLE AXLE”, U.S. Pat. No. Des. 355,919, entitled “COMBINED AGRICULTURAL-SPRAYER AND APPLICATOR”, U.S. Pat. No. 5,355,815, entitled “CLOSED-LOOP VARIABLE APPLICATOR”, U.S. Pat. No. 4,700,895, entitled “HYDRAULIC METERING CONTROL”, U.S. Pat. No. 5,689,418, entitled “AGRICULTURAL COMMUNICATION NETWORK”, U.S. Pat. No. 4,964,575, entitled “BOOM FLOW CONTROL MECHANISM FOR PNEUMATIC SPREADERS”, U.S. Pat. No. 4,449,725, entitled “SUPPORT FOR BOOMS AND OTHER FIELD EQUIPMENT”, U.S. Pat. No. 4,515,311, entitled “LIQUID WASTE APPLICATION SYSTEM WITH SLUDGE GUN”, U.S. Pat. No. 5,028,009, entitled “DISTRIBUTOR HEAD FOR USE WITH BOOMS HAVING SHUT-OFF CAPABILITY”, U.S. Pat. No. Des. 323,174, entitled “DISTRIBUTION HEAD FOR PARTICULAR MATERIAL”, U.S. Pat. No. 5,870,686, entitled “INTELLIGENT MOBILE PRODUCT APPLICATION CONTROL SYSTEM”, and U.S. Pat. No. 5,757,640, entitled “PRODUCT APPLICATION CONTROL WITH DISTRIBUTED PROCESS MANAGER FOR USE ON VEHICLES”. These patents are hereby incorporated by reference.

Complex software-based systems, such as those used in site specific farming, often involve either a single monolithic application, or involve multiple software modules with multiple user interfaces. For systems with multiple software modules, a user must often write scripts that “tie” the software modules together by invoking them in the desired order and defining how data is passed between modules. For modules that generate data files that are to be used by other modules, the user must be careful to appropriately reference the shared data files in all of the appropriate scripts. It is a difficult and time consuming task to make sure that all of the shared data files are appropriately referenced. In addition, it is not a simple process to make modifications to such existing software-based systems for several reasons. First, changes will typically need to be made by a person with a programming background and with a detailed understanding of the software to be changed. Second, the software must typically be re-compiled every time a person wants to make a change in the way data is processed by the software. Third, a change to one module may affect other modules as well, requiring all affected modules to be re-compiled.

It would be desirable to use a more flexible and efficient approach than that provided by current complex, software-based systems. Such a system would ideally eliminate the need to write separate script files, and would allow easy modification without the need for a programming background and without the need to re-compile the software after each change.

### BRIEF SUMMARY OF THE INVENTION

The software-based system of the present invention uses a single document, referred to as an “application plan”, which defines all of the important data to be used in a database analysis and specifies what data analyses are to be performed. A plurality of software modules in the system process the application plan. Files that will be used by multiple software modules need only be defined once in the application plan.

Each software module in the system performs a common set of operations using the application plan. The set of operations are referred to as “Transform”, “Sequence”, and “Invoke” (TSI) operations. The first operation performed by a software module is to “transform” the application plan so that it is appropriate for that module. Next, the software module determines a “sequence” of operations to be performed and identifies other software modules to be invoked. The software module then executes the sequence of operations and “invokes” the other identified software modules in the correct sequence, and passes the invoked software modules a copy of the transformed application plan. During processing of an application plan, software modules are constantly performing the operations of transform, sequence, and invoke.

The TSI paradigm of the present invention allows a user to completely specify his or her wishes in the application plan, and the user never needs to be concerned with the programming details of the software modules. A transform or transforms and a decision tree can be written such that all of the hard-coded software components, which are expensive to create and modify, can be told specifically what they need to do to generate the desired result. A decision tree is a document that defines a series of software modules to be invoked, and a desired order for invoking the modules.

The TSI process of the present invention facilitates the retrieval of data from large databases and analysis of that data for historical trends and other purposes. Databases in the site specific farming context include historical data, such as the composition of a field from year to year and crop yield from year to year. Because such databases are so large and complex, they are difficult to analyze. Rather than having a large monolithic chunk of code for accessing data from the databases and processing that data, the present invention uses several small bits of code in the form of software modules. Each software module understands a small portion of the databases and understands how to best summarize that piece of the databases. The various software modules are “wired” together as specified in the decision tree, resulting in a very complex process that can easily be changed by changing the wiring of the components, replacing components or adding new components.

An application plan does not specify how a system is to perform to deliver the desired results. The application plan merely specifies what is to happen. How the analysis proceeds is a function of the transforms and the decision tree. Given a single application plan, there may be several ways to achieve the desired results. The transforms and the decision tree determine the actual steps that will be taken to provide the desired results.

The use of an application plan and transforms provides for a great deal of flexibility for site specific farming applications. The main goal in this context is to maximize profit by maximizing yield, and this may be accomplished in different ways. Therefore, it is important to maintain flexibility throughout the process, and not be forced to go back to the software developer each time a new step is added or a different order of execution is desired.

Agronomists are the individuals who are best suited to determine whether the results of a database analysis are accurate or not. However, most agronomists are not computer programmers and must, therefore, return to the computer programmers every time they want to change the analysis process. It becomes very expensive and time consuming to repeatedly return to the programmer, and have the programmer develop new sets of instructions to analyze the system databases in new ways. The TSI process allows the agronomist to wire software modules together as he chooses with little or no programming. Development of the transforms and decision tree does not require computer programming skills, only a knowledge of the syntax of the logic to be expressed.

The TSI process is particularly beneficial when third parties are hired to create new software modules for a system. The programmers who write the new software modules do not need to know the format of the application plan. The programmers need only specify the format of the data to be input into the new software modules, and a transform can modify the data from the application plan to make it appropriate for the new software modules. The application plan does not have to be changed to suit the needs of the third party in creating the new software modules. As new software modules are added, only the transforms and decision tree need to be updated. Individual modules do not have to be updated and re-compiled.

In a preferred embodiment, the invention comprises a software-based system and method for analyzing data contained in a computerized database. A plan document specifies data to be used by each of a plurality of software modules. A decision tree document identifies a set of the software modules to be invoked and specifies an order in which the identified set of software modules are to be invoked. Each of the identified set of software modules are provided a version of the plan document. Each version of the plan document provided to each of the identified set of software modules is transformed into a transformed plan document such that each one of the identified set of software modules has an associated transformed plan document. The transformed plan document associated with each module includes only a subset of the data contained in the version of the application plan provided to the software module. The identified set of software modules are invoked in the order specified in the decision tree. Each of the identified set of software modules performs operations using data from the transformed plan document associated with the software module. The identified set of software modules retrieves data from the computerized database and processes the retrieved data.

In an alternative preferred embodiment, the invention comprises a system and method for generating application maps for use in dispensing material on a field on a site-specific basis according to field conditions. An application plan is generated. The application plan identifies a product to be dispensed on a field and application rate equations for determining dispensing rates by field location of a material to be dispensed on the field. A version of the application plan is provided to each of a plurality of software modules. Each software module transforms the received version of the application plan into a transformed application plan. The plurality of software modules are invoked in a specified order to generate an application map.

### BRIEF DESCRIPTION OF THE DRAWINGS

FIG. 1 shows a block diagram of a map development system for developing application maps for site specific farming applications.

FIG. 2 shows an example of an application plan according to the present invention.

FIG. 3 shows an example of a decision tree according to the present invention.

FIG. 4 shows a more detailed representation of the map development system shown in FIG. 1.

### DETAILED DESCRIPTION

I. Overview of Map Development System

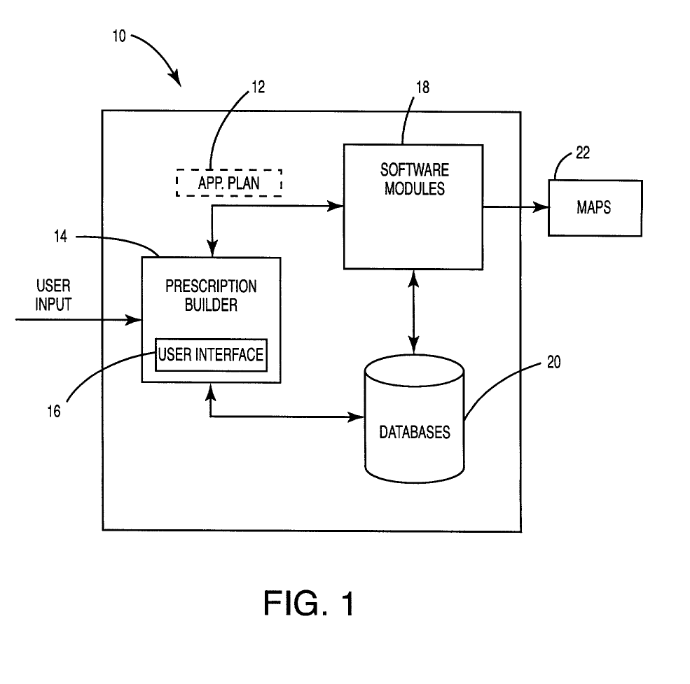

FIG. 1 shows map development system 10, which develops application maps for site specific farming applications. Map development system 10 includes prescription builder 14, prescription lab user interface 16, software modules 18, databases 20 and maps 22. Maps 22 include agronomic prescription maps, demo application maps and real application maps. Agronomic prescription maps identify quantities of components, such as nitrogen, potassium and phosphorus, to be added to a field on a site specific basis. Components such as nitrogen can not be purchased and spread individually. Rather, substances such as diammonium phosphate or urea, which include the recommended components, must be spread. Thus, agronomic prescription maps are used to produce demo application maps, which identify actual products to be added to a field on a site specific basis. The final step in the map generation process is to produce a real application map that can be used by controllers in agricultural vehicles to automatically control the quantities of products that are spread over a field.

II. Creation of an Application Plan

Prescription builder 14 builds an application plan 12 based on user input and on data contained in databases 20. Application plan 12 is a document that describes completely and unambiguously the intentions of a user for creating application maps for a field. Application plan 12 is preferably specified using terminology that is familiar to the user. The user is, therefore, isolated from the programming details of how the plan will be carried out by software modules 18 to provide the desired results.

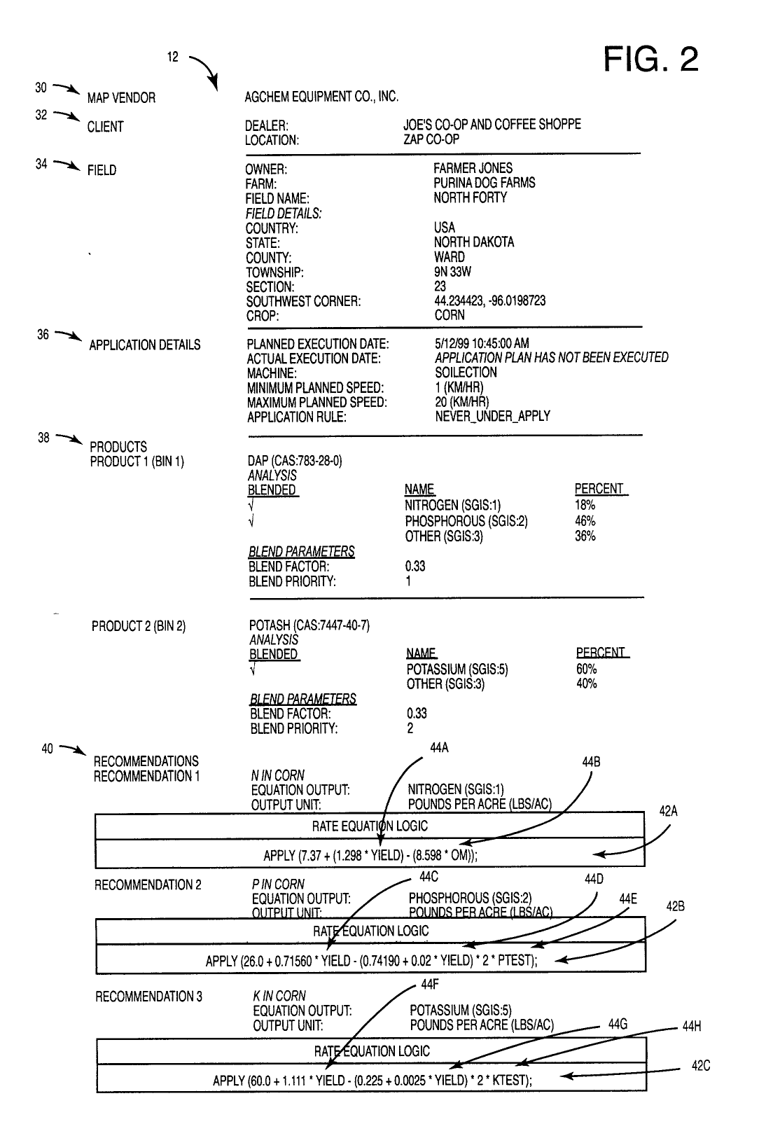

FIG. 2 shows an example of an application plan 12. Application plan 12 includes map vendor information 30, client information 32, field information 34, application details 36, product information 38, and recommendations 40.

Map vendor information 30 includes information about the company producing an application map for a client, such as the company name, and may also include other general information such as address, phone number, e-mail address, and similar information. Client information 32 provides information about the client for whom an application map is being generated, and preferably includes the same types of information contained in map vendor information 30. Field information 34 includes details about the field or fields for which an application map is being generated, including information regarding the field owner, field name, field location, field boundaries and crops grown on the field.

Application details 36 include information about the execution of an application map. Specifically, application details 36 identify when the application map is to be executed, the type of machine that will perform the execution of the application map, minimum and maximum speeds of the machine, and rules to be followed by the machine in executing the application map.

Product information 38 includes information about the products to be spread on a field, including the type of product (e.g., diammonium phosphate or DAP, and Potash) to be contained in each bin of the spreading machine, the composition of the products including component names and percentages, indications of whether the components are blended, and blend parameters. Blending of components and blend parameters are discussed below after a description of recommendations 40. Next to each component name in product information 38 is a corresponding variable name in parentheses. The variable name begins with “sgis:” and ends with a number.

Recommendations 40 include rate equations 42A-42C (collectively referred to as rate equations 42), which are used in producing an agronomic prescription map. Databases 20 contain pre-defined rate equations that may be selected and used for application plan 12. Alternatively, a user may modify the pre-defined equations or create new equations.

An agronomic prescription map indicates the quantity of nitrogen, phosphorus, and potassium that should be applied at various regions in a field given certain soil test information about the field and yield goal data. The soil test information preferably includes test results for nitrogen (N), phosphorus (P), potassium (K) and organic matter (OM). The soil test data is referenced in rate equations 42 by a plurality of input variables 44A-44H (collectively referred to as input variables 44). Input variables 44 include “yield”, “om”, “pTest”, “kTest” and “nTest” (“nTest” is not shown in FIG. 2). “Yield” refers to goals or predictions for crop yield for a particular field. “Om”, “pTest”, “kTest” and “nTest” refer to organic matter test data, phosphorus test data, potassium test data and nitrogen test data, respectively. When rate equations 42 are evaluated, the data corresponding to input variables 44 are accessed from databases 20, and recommendations are generated for nitrogen, phosphorus, and potassium on a site-specific basis. Rate equations 42 may be input using mathematical equations, nested programming, or tables. As a simple example, a user may enter a rate equation such as the following:

If nTest < 30 then

Apply (nTest * 0.3) + 5.2

Else

Apply (0)

End if

It is unlikely that products will be available to exactly meet the recommendations for nitrogen, potassium and phosphorus that are derived from rate equations 42. It is difficult if not impossible to satisfy all three of these recommendations exactly. Thus, the user must specify priorities and blend factors. As shown in FIG. 2, under product information 38, a blend factor of “0.33” and a blend priority of “1” are listed for product 1 (i.e., DAP). A blend factor of “0.33” and a blend priority of “2” are listed for product 2 (i.e., Potash). The blend factor and blend priority are used by a spatial blending module (discussed below) to generate an application map, which identifies products to be added to a field on a site specific basis.

Prescription lab user interface 16 includes a template or a set of rules which define what application plan 12 must look like in order to be processed through to completion. From the perspective of user interface 16, application plan 12 can be looked at as a worksheet that needs to be filled out completely before it can be processed. If the information in an application plan 12 is not complete, user interface 16 prompts the user to fill in the missing information. User interface 12 queries a user for various instructions about how the user wants the application plan to proceed. Such queries include: (1) Does the user want demo or real application maps, (2) what kind of interpolation does the user want to perform on rate equation input variables 44, (3) what machine will do the product spread and what products will go in which bins of the spreading machine, and (4) what sort of blending logic does the user want and what is the priority of the blending inputs?

Much of the information to be included in application plan 12 is preferably already stored in databases 20 within map development system 10. Such stored information includes pre-defined rate equations 42 and product composition information. Based on the data input and selections made by a user, user interface 16 retrieves XML (extensible mark-up language) blocks from databases 20 in the form of equations, products and other data, and creates an XML version of application plan 12. The XML version of application plan 12 preferably has several nodes, including an application plan node, a shared data node, a recommendations node and a spread maps node. The application plan node includes attributes that identify the working directory to process the application plan in, the version of the document, and the timestamp of when the document was last modified. The shared data node describes various meta data about the application plan such as where and for whom it is being generated. The recommendations node stores all of the rate equations 42 that will be used to generate agronomic prescription maps. Implicit in the rate equations are the input variables 44 that will be used. The spread maps node describes which products are going to be spread, how they will be blended, whether the maps will be real or demo, and the machine that will do the spreading

III. Processing of an Application Plan

After an application plan 12 has been completed, the plan 12 is processed by software modules 18. Prescription builder 14 invokes one of software modules 18 and passes it a copy of application plan 12. All software modules 18 perform essentially the same general initial operations when they receive an application plan 12. First, a software module 18 “transforms” the received application plan 12 to make it appropriate for that module 18. In a preferred embodiment, the transformation performed by each software module 18 is made using an extensible style language (XSL) stylesheet. Next, a software module 18 determines a “sequence” of operations to be performed and identifies other software modules 18 to be invoked. The software module 18 then executes the sequence of operations and “invokes” the other software modules 18 in the correct sequence, and passes these software modules 18 a copy of the transformed application plan 12.

The TSI paradigm of the present invention allows a user to completely specify his or her wishes in the application plan 12, and the user never needs to be concerned with the programming details of software modules 18. A transform or transforms and a decision tree can be written such that all of the hard-coded software components, which are expensive to create and modify, can be told specifically what they need to do to generate the desired result. In a preferred embodiment, a decision tree is an XML document that identifies a series of software modules 18 to be invoked, the order in which the modules 18 will be invoked, and which stylesheets will be passed to the invoked modules 18. Conceptually, a decision tree is essentially a graph with nodes, where each node represents a module 18, and each module 18 has associated with it a particular stylesheet. The stylesheet associated with a particular module 18 is specified in the decision tree. Therefore, to change the analysis process, changes can be made to a particular module 18 or alternatively changes may be made to the stylesheet that gets passed to that module 18. The order in which a particular analysis occurs can be changed without recompiling or altering a single binary module 18 by changing the decision tree.

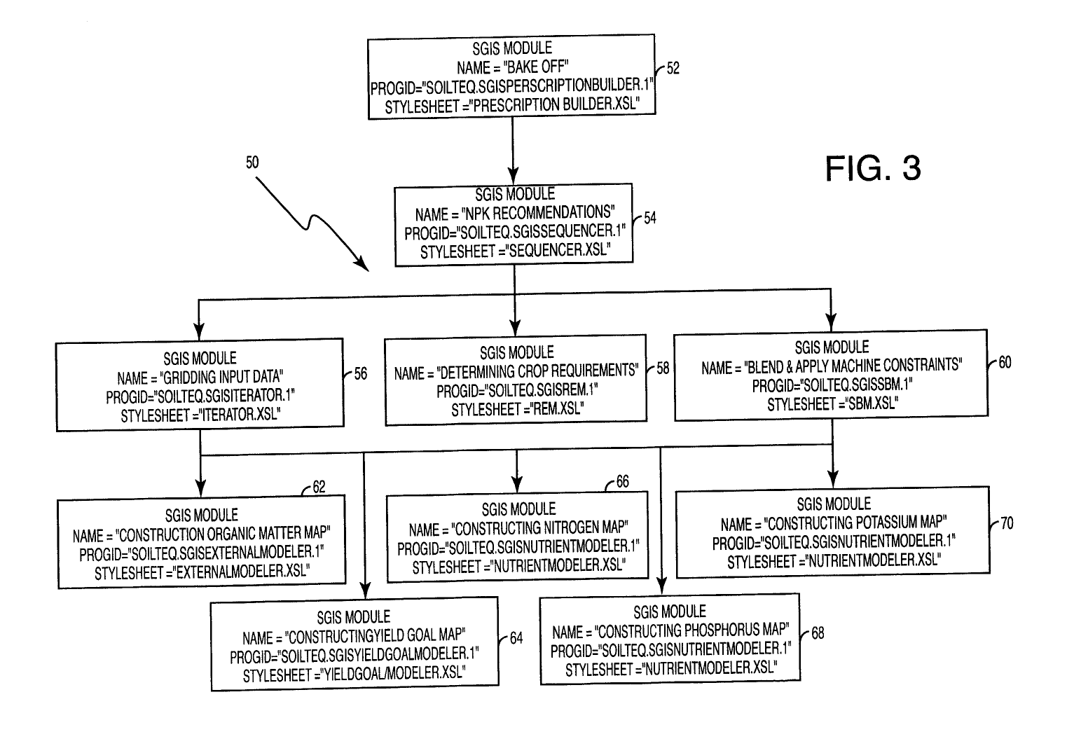

FIG. 3 shows a flow diagram representation of a decision tree. Decision tree 50 includes a plurality of nodes 52-70. Each one of nodes 52-70 corresponds to a particular software module 18. Each one of nodes 52-70 includes four lines of information. The first line identifies the type of the module 18 corresponding to that node. As can be seen in FIG. 3, all of the modules corresponding to nodes 52-70 are of the same type (i.e., “SgisModule”), although multiple module types may be used. The second line of each of nodes 52-70 identifies a descriptive name for the module 18 corresponding to that node. The descriptive name preferably indicates the intended use of the module 18. The third line of each of nodes 52-70 identifies the actual name of the software module 18 corresponding to that node. The fourth line of each of nodes 52-70 identifies the stylesheet that is to be applied to a received application plan 12 by the software module 18 corresponding to that node.

The layout of decision tree 50 determines how a database analysis is to proceed. Software modules 18 are invoked in the order defined by decision tree 50, starting at the top of decision tree 50, moving down through each level of decision tree 50, and moving from left to right across each level. Therefore, according to decision tree 50, the first module 18 to be invoked is “SOILTEQ.SgisPrescriptionBuilder.1”. (Node 52). This first module 18 applies stylesheet “Prescription Builder.xsl” to the application plan 12 and generates a transformed application plan. The first module 18 then invokes the next module 18 in decision tree 50, which is “SOILTEQ.SgisSequencer.1”. (Node 54). The first module 18 (node 52) passes the transformed application plan to the second module 18 (node 54), and also passes the stylesheet that is identified in decision tree 50 as being appropriate for the second module 18 (i.e., “Sequencer.xsl”). The second module 18 (node 54) applies the “Sequencer.xsl” stylesheet to the received application plan 12, further refining the application plan 12, and generates its own transformed application plan.

Each stylesheet extracts data from the received version of the application plan 12 and re-formats the data so that it matches the vocabulary and instruction requirements of the software module 18 associated with the stylesheet. For example, if application plan 12 specifies a field boundary like the following:

<field_boundary FID=“22” database=“c:\Sgis.mdb”/>

And if one of the software modules 18 specifies the same information as follows:

<field_boundary_ID>22</field boundary_ID>

<database>C:\Sgis.mdb</database>

The stylesheet will re-format the field boundary data from application plan 12 to match the format specified by the software module 18. Also, the format of the field boundary information may change in future application plans, and could be specified as follows:

<field>

<boundary>

<ID>22</TD>
<database>c:\Sgis.mdb</database>

<boundary>

</field>

The existing software modules 18 could still be used to process the new application plan, as long as the stylesheets are modified to take into account the new format for the field boundary information.

The transformed application plan generated by the first module 18 is referred to as the first derivative of the application plan 12 with respect to the first module 18. The transformed application plan generated by the second module is referred to as the second derivative of the application plan 12 with respect to the second module 18. If the first module 18 were to pass its transformed application plan to a third module 18, the transformed application plan generated by the third module 18 would be referred to as the second derivative of the application plan with respect to the third module 18.

Modules 18 are invoked as defined in decision tree 50 until the last module 18 has been invoked. Thus, the module 18 corresponding to node 54 will invoke the module 18 corresponding to node 56, which will then invoke the modules 18 corresponding to nodes 62, 64, 66, 68 and 70. Next, the module 18 corresponding to node 54 will invoke the module 18 corresponding to node 58, and then invoke the module 18 corresponding to node 60. After the module 18 corresponding to node 60 performs its tasks, the database analysis process is complete.

IV. Map Development System Software Modules

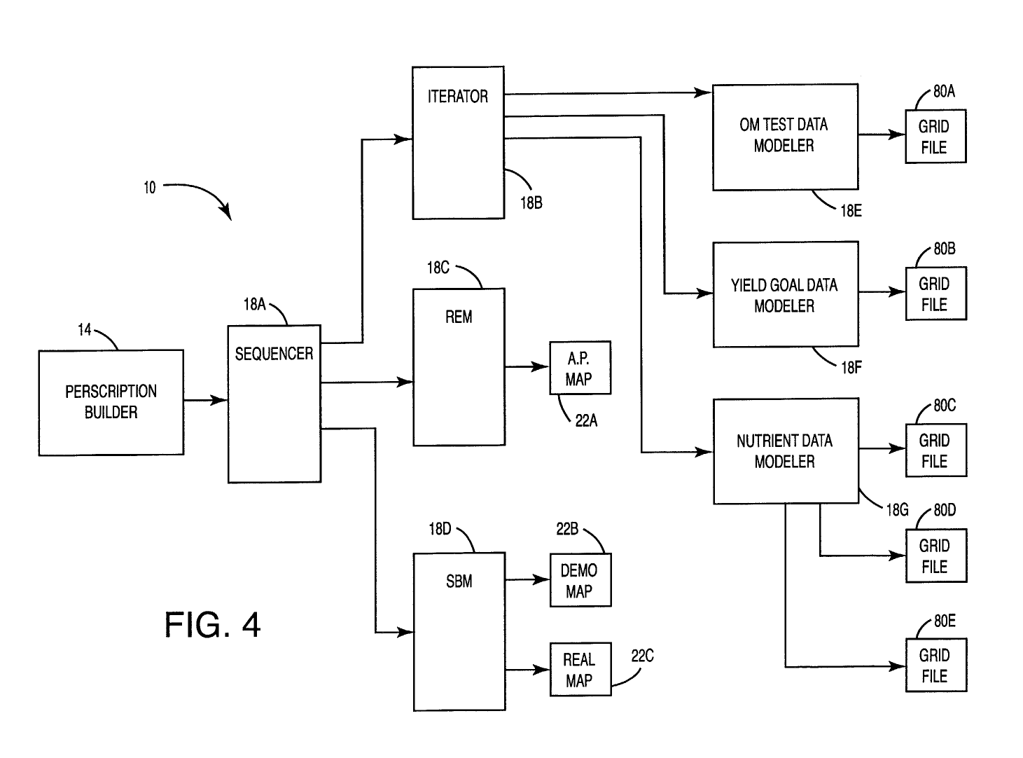

Next, map development system 10 is described in more detail to further illustrate the TSI process of the present invention. As shown in FIG. 4, map development system 10 includes prescription builder 14, sequencer module 18A, iterator module 18B, recommendation equation module (REM) 18C, spatial blending module (SBM) 18D, organic matter (OM) data modeler module 18E, yield goal data modeler 18F and nutrient data modeler module 18G. Prescription builder 14 corresponds to node 52 of decision tree 50. Modules 18A-18F correspond to nodes 54-64, respectively, of decision tree 50. Module 18G corresponds to nodes 66, 68 and 70, which indicates that module 18G is invoked three times.

Map development system 10 must perform a number of operations in order to turn an application plan 12 into useable product application maps 22. First, iterator module 18B determines what data is required by rate equations 42, retrieves that data and generates “grid files”. Grid files are discussed below. REM 18C accesses the grid files and generates agronomic prescription maps based on the rate equations 42 and the data contained in the grid files. SBM 18D accesses the agronomic prescription maps generated by REM 18C, and generates demo application maps and real application maps. Each of these operations in discussed in further detail below.

The outputs of one software module 18 are usually the inputs to one or more downstream software modules 18. The data exchanged between software modules 18 is referred to as a “grid file.” For example, the data modeler modules 18E-18G output grid files 80A-80E (collectively referred to as grid files 80), which are used as inputs to REM 18C. In addition to the grid files 80 created by data modeler modules 18E-18G, another example of shared files are the outputs of REM 18C and the inputs of SBM 18D. REM 18C outputs agronomic prescription maps 22A, and SBM 18D uses the agronomic prescription maps 22A as inputs. An agronomic prescription map 22A is, therefore, also referred to as a grid file.

In a preferred embodiment, grid files 80 are stored as tif images. XML provides a mechanism that helps to ensure that a given tif image is represented identically in all instances within a document. These XML mechanisms are referred to as “entity” declarations. Entities are declared in the prolog (analogous to a header) of an application plan 12 and act as constants that can be referenced anywhere within the document as long as their placement does not violate the rules outlined in the Document Type Definition (DTD). In the context of an application plan 12, any item that appears more than once within the application plan document and that takes part in an input/output relationship is declared as an entity in the document prolog and referenced accordingly. Each grid file 80 has one and only one declaration, and any piece of the application plan 12 that will create or use that grid file has a reference to that declaration. By declaring files such as agronomic prescription maps 22A as entities, any change to the agronomic prescription maps 22A in one context are reflected in the entire application plan 12.

A. SEQUENCER MODULE

As discussed above, prescription builder 14 assists a user in constructing an application plan 12. A decision tree 50 is also constructed (See FIG. 3). After application plan 12 and decision tree 50 have been constructed, prescription builder 14 invokes sequencer module 18A and passes to sequencer module 18A the following: (1) application plan 12, (2) decision tree 50, and (3) a stylesheet identified in decision tree 50 as being appropriate for sequencer module 18A (i.e., “Sequencer.xsl”, as indicated by node 54 of decision tree 50). Sequencer module 18A applies the received stylesheet to the received application plan 12 and generates a transformed application plan that is appropriate for sequencer module 18A. The application plan 12 as transformed by sequencer module 18A is referred to as the first derivative of the application plan with respect to the sequencer module.

Sequencer module 18A knows from the received decision tree 50 that sequencer module 18A must invoke iterator module 18B (node 56), REM 18C (node 58) and SBM 18D (node 60), in that order. When sequencer module 18A invokes another module 18, sequencer module 18A passes the invoked module 18: (1) the first derivative of the application plan 12 with respect to the sequencer module 18A, (2) decision tree 50, and (3) a stylesheet identified in the decision tree 50 as being appropriate for the invoked module 18.

After iterator module 18B is invoked and performs its operations, control is returned to sequencer module 18A, which then invokes REM 18C. Similarly, after REM 18C performs its operations, control is returned to sequencer module 18A, which then invokes SBM 18D. The operations performed by iterator module 18B, REM 18C and SBM 18D are discussed in further detail below.

B. ITERATOR MODULE AND DATA MODELERS

When iterator module 18B is invoked by sequencer module 18A, iterator module 18B applies the received stylesheet (i.e., “Iterator.xsl”, as indicated by node 56 of decision tree 50) to the received first derivative of the application plan 12 with respect to the sequencer module 18A, and generates a transformed application plan that is appropriate for iterator module 18B. In particular, the stylesheet used by iterator module 18B sorts out of the received application plan document all of the references to rate equation input variables 44. Because the rate equation input variables 44 are stored in the recommendations node of the application plan 12, the stylesheet used by iterator module 18B need only search this node of the application plan 12 for the variables 44, rather than the entire application plan 12. The application plan 12 as transformed by iterator module 18B is referred to as the second derivative of the application plan with respect to the iterator module.

Iterator module 18B analyzes the decision tree 50 received from sequencer module 18A. Decision tree 50 indicates that iterator module 18B is to invoke modules 18E-18G, which retrieve soil test data and yield goal data from databases 20 and generate grid files 80. The soil test data preferably include test results for nitrogen (N), phosphorus (P), potassium (K) and organic matter (OM) at various regions of a field. Iterator module 18B invokes each of modules 18E-18G 18G in turn, and passes them: (1) the second derivative of the application plan 12 with respect to the iterator module 18B, (2) decision tree 50, and (3) a stylesheet identified in the decision tree 50 as being appropriate for the invoked module. When invoked by iterator module 18B, each data modeler module 18E-18G applies the received stylesheet to the received second derivative of the application plan 12 with respect to the iterator module 18B, and generates a transformed application plan that is appropriate for the particular data modeler module. In particular, the stylesheet used by each data modeler module 18E-18G sorts out of the received application plan document any references to rate equation input variables 44 that correspond to the data modeler. More specifically, OM test data modeler module 18E extracts any references to “om” input variables 44, yield goal data modeler module 18F extracts any references to “yield” input variables 44 and nutrient data modeler module 18G extracts any references to “nTest”, “pTest” and “kTest” input variables 44. Data modeler modules 18E-18G also extract field identification and boundary data from the received application plan, so that data modeler modules 18-18G know the field for which test data is to be obtained.

Based on soil test data retrieved from databases 20, OM test data modeler 18E generates an OM-test grid file 80D that indicates the quantity of organic matter at various regions of a field. Yield goal data modeler 18J generates a yield goal grid file 80E that indicates a desired or predicted yield for a field on a site specific basis. Based on soil test data retrieved from databases 20, nutrient data modeler module 18G generates an N-test grid file 80C indicating the quantity of nitrogen at various regions of a field, a P-test grid file 80D that indicates the quantity of phosphorus at various regions of a field and a K-test grid file 80E that indicates the quantity of potassium at various regions of a field. As indicated by nodes 66, 68 and 70 of decision tree 50, nutrient data modeler 18G is invoked three times; one time for each type of grid file 80 it generates. Nutrient data modeler 18G may alternatively be divided into three separate modules, each with its own stylesheet.

In generating a grid file 80, modules 18E-18G essentially place a grid over a certain field and thereby divide the field into various regions. Databases 20 may not include soil samples for each region in the grid. For such situations, modules 18E-18G perform an interpolation operation to estimate soil sample values in the regions for which soil samples are not available. Details regarding the interpolation operation may be specified in application plan 12.

All rate equation input variables 44 are tied to a data source. Data sources for input variables 44 include soil tests, crop scouting data, yield maps and yield goal data. Other sources may also be used. All input variables 44 included in an application plan 12 preferably declare which of the data sources they are tied to, and declare the units that data are to be expressed in. Map development system 10 stores data in a standard unit set and then converts the units during input and output. Therefore, rather than forcing a user to convert the user's equations to a preferred unit set, map development system 10 automatically converts data based on its stored knowledge about units. The data source information and the unit information declared for input variables 44 allows data modeler modules 18E-18G to locate the correct data, conform the units and generate grid files 80.

Because of the flexibility of the present invention, the simple data modeler modules 18E-18G, which merely access databases 20 and output grid files 80, can be replaced by more complex data modelers that perform complex processing such as performing agronomy on the soil tests. For example, if the complex data modelers were given the fact that a nitrogen test for a field was performed three years ago, and in the past three years a specified set of crops were planted and a specified set of chemicals were applied, the complex data modelers would recognize that the soil test is not up-to-date, and would make an educated guess or prediction of soil test results based on the available data. The complex data modelers could be inserted into the system by changing the decision tree, and possibly modifying the stylesheets.

C. RECOMMENDATION EQUATION MODULE (REM)

After iterator module 18B completes its task of invoking data modeler modules 18E-18G to generate grid files 80, control is returned to sequencer module 18A, which then invokes REM 18C. REM 18C receives a stylesheet from sequencer module 18A (i.e., “REM.xsl”, as indicated by node 58 of decision tree 50) and applies the stylesheet to the received first derivative of the application plan 12 with respect to the sequencer module 18A, and generates a transformed application plan that is appropriate for REM 18C. In particular, the stylesheet used by REM 18C sorts out of the received application plan document all of the references to rate equations 42. Rate equations 42 are stored in the recommendations node of the application plan 12, so the stylesheet used by REM 18C need only search this node of application plan 12 for the data. The application plan 12 as transformed by REM 18C is referred to as the second derivative of the application plan with respect to the REM.

REM 18C executes the rate equations defined in the second derivative of the application plan 12 with respect to the REM, and generates an agronomic prescription map 22A that indicates how much nitrogen, phosphorus, and potassium should be applied at various regions of a field. During execution of the rate equations, REM 18C replaces the input variables 44 in the rate equations with data from the grid files 80 created by data modeler modules 18E-18G.

D. SPATIAL BLENDING MODULE (SBM)

After REM 18C generates agronomic prescription map 22A, control is returned to sequencer module 18A, which then invokes SBM 18D. SBM 18D receives a stylesheet (i.e., “SBM.xsl”, as indicated by node 60 of decision tree 50) from sequencer module 18A and applies the stylesheet to the received first derivative of the application plan 12 with respect to the sequencer module 18A, and generates a transformed application plan that is appropriate for SBM 18D. In particular, the stylesheet used by SBM 18D sorts out of the received application plan document all of the references to products that are to be spread, blending instructions, whether the maps will be real or demo and the machine that will do the spreading. These data are preferably stored in the spread maps node of the application plan 12, so the stylesheet used by SBM 18D need only search this node of application plan 12 for the data. The application plan 12 as transformed by SBM 18D is referred to as the second derivative of the application plan with respect to the SBM.

SBM 18D is responsible for creating demo application maps and real application maps. Components such as nitrogen and phosphorus can not be purchased and spread individually. Rather, a substance such as diammonium phosphate or urea, which includes the recommended components, must be spread. Thus, SBM 18D takes the nitrogen, phosphorus, and potassium layer recommendations output by REM 18C (in the form of agronomic prescription map 22A), compares the data to the chosen products listed in application plan 12, and blends everything together in the form of an application map that most closely matches the component recommendations. In generating an application map, SBM 18D uses the blend factors and blend priorities listed in the application plan 12 to ensure that the generated map matches the user's wishes as close as possible.

SBM 18D generates both demo application maps 22B and real application maps 22C. Demo application maps 22B are maps that can be displayed on a monitor or printed for viewing by a user. Real application maps 22C include the same data as demo application maps 22B, but are not displayed to a user. Rather, real application maps 22C are used by controllers in agricultural vehicles to automatically control the dispensing rates of products that are spread over a field.

In summary, the TSI process of the present invention facilitates the retrieval of data from large databases and analysis of that data, and is particularly useful in the site specific farming context. It is important in the site specific farming context to maintain flexibility throughout the process, and not be forced to go back to the software developer each time a new step is added or a different order of execution is desired. The TSI process allows an agronomist or other individual to wire software modules together as he chooses with little or no programming. In addition, new software modules are easily incorporated into the system. The application plan does not have to be changed to suit the needs of the party developing the new software modules, and the new software modules do not have to comply with the format of the application plan. Rather, transforms and a decision tree are created to incorporate the new software modules and re-format data to make it appropriate for the new software modules.

Although the present invention has been described with reference to preferred embodiments, workers skilled in the art will recognize that changes may be made in form and detail without departing from the spirit and scope of the invention.

1. A system for generating application maps for use in dispensing material on a field on a site-specific basis according to field conditions, the system comprising:
means for generating an application plan, the application plan identifying a product to be dispensed on a field and application rate equations for determining dispensing rates by field location of a material to be dispensed on the field; and
a plurality of software modules, each software module receiving a version of the application plan and transforming the received version of the application plan into a transformed application plan, the plurality of software modules invoked in a specified order to generate an application map.

2. The system of claim 1 wherein the transformed application plan generated by each software module includes only a subset of the data contained in the received version of the application plan.

3. The system of claim 1 wherein the application plan is an XML document.

4. The system of claim 1, and further comprising storage means for storing field condition data and application rate equations.

5. The system of claim 1, and further comprising a user interface for entering data for the application plan.

6. The system of claim 1, and further comprising a decision tree that specifies an order in which the software modules are to be invoked.

7. The system of claim 6 wherein the decision tree is an XML document.

8. The system of claim 4 wherein at least one of the software modules obtains field condition data from the storage means and generates a grid file that identifies a field condition on a site-specific basis.

9. The system of claim 8 wherein the identified field condition is one of yield potential, nitrogen level, potassium level, phosphorus level and organic matter level.

10. The system of claim 8 wherein at least one of the software modules is a recommendation module that generates a prescription map based on the grid file and on rate equations contained in a transformed application plan generated by the recommendation module, the prescription map identifying dispensing rates by field location of at least one component of a commercial product.

11. The system of claim 10 wherein at least one of the software modules is a blending module that generates an application map based on the prescription map and blending instructions contained in a transformed application plan generated by the blending module, the application map identifying dispensing rates by field location of at least one commercial product.

12. A method of generating application maps for use in dispensing material on a field on a site-specific basis according to field conditions, the method comprising:
generating an application plan, the application plan identifying a product to be dispensed on a field and application rate equations for determining dispensing rates by field location of a material to be dispensed on the field;
providing a version of the application plan to each of a plurality of software modules, each software module transforming the received version of the application plan into a transformed application plan; and
invoking the plurality of software modules in a specified order to generate an application map.

13. The method of claim 12 wherein the transformed application plan generated by each software module includes only a subset of the data contained in the version of the application plan provided to the software module.

14. The method of claim 12 wherein the application plan is an XML document.

15. The method of claim 12, and further comprising:
storing field condition data and application rate equations.

16. The method of claim 12, and further comprising:
entering data for the application plan with a user interface.

17. The method of claim 12, wherein the order in which the software modules are to be invoked is specified in a decision tree.

18. The method of claim 17 wherein the decision tree is an XML document.

19. The method of claim 15, and further comprising:
retrieving field condition data from a storage means; and
generating a grid file based on the retrieved field condition data, the grid file representing a field condition for a field on a site-specific basis.

20. The method of claim 19 wherein the identified field condition is one of yield potential, nitrogen level, potassium level, phosphorus level and organic matter level.

21. The method of claim 19 wherein at least one of the software modules is a recommendation module that generates a prescription map based on the grid file and on rate equations contained in a transformed application plan generated by the recommendation module, the prescription map identifying dispensing rates by field location of at least one component of a commercial product.

22. The method of claim 21 wherein at least one of the software modules is a blending module that generates an application map based on the prescription map and blending instructions contained in a transformed application plan generated by the blending module, the application map identifying dispensing rates by field location of at least one commercial product.

23. A software-based method of analyzing data contained in a computerized database comprising:
providing a plurality of software modules;
providing a plan document that specifies data to be used by at least one of the software modules;
providing a decision tree document that identifies a set of the software modules to be invoked and specifies an order in which the identified set of software modules are to be invoked;
providing a version of the plan document to each software module in the identified set of software modules;
transforming each version of the plan document provided to each of the software modules into a transformed plan document such that each software module in the identified set of software modules has an associated transformed plan document; and
invoking the identified set of software modules in the order specified in the decision tree, each software module in the identified set of software modules performing operations using data from the transformed plan document associated with the software module, the identified set of software modules retrieving data from the computerized database and processing the retrieved data.

24. The method of claim 23 wherein the plan document is an XML file.

25. The method of claim 23 wherein the decision tree document is an XML file.

26. The method of claim 23 wherein the decision tree document is provided to each software module in the identified set of software modules.

27. The method of claim 23, and further comprising providing a stylesheet to each software module in the identified set of software modules, each stylesheet used in transforming the plan document.

28. A software-based system for analyzing data contained in a computerized database comprising:
a plurality of software modules;
a plan document that specifies data to be used at least one of the software modules;
a decision tree document that identifies a set of the software modules to be invoked and specifies an order in which the identified set of software modules are to be invoked;
means for providing a version of the plan document to each software module in the identified set of software modules;
means for transforming each version of the plan document into a transformed plan document such that each software module in the identified set of software modules has an associated transformed plan document; and
means for invoking the identified set of software modules in the order specified in the decision tree, each software module in the identified set of software modules performing operations using data from the transformed plan document associated with the software module, the identified set of software modules retrieving data from the computerized database and processing the retrieved data.

29. The system of claim 28 wherein the plan document is an XML file.

30. The system of claim 28 wherein the decision tree document is an XML file.

31. The system of claim 28 wherein the decision tree document is provided to each software module in the identified set of software modules.

32. The system of claim 28 wherein the means for transforming is a stylesheet.
